(19) United States
(12) Patent Application Publication
(10) Pub. No.: US 2022/0097269 A1
(43) Pub. Date: Mar. 31, 2022

(54) Mold, injection molding method and related cap with internal protruding portions

(71) Applicant: BISIO PROGETTI S.P.A., ALESSANDRIA (IT)

(72) Inventor: Luigi BISIO, ALESSANDRIA (IT)

(21) Appl. No.: 17/425,465

(22) PCT Filed: Mar. 18, 2020
(86) PCT No.: PCT/IB2020/052445

§ 371 Date: Jul. 23, 2021

(30) Foreign Application Priority Data
Mar. 20, 2019 (IT) 102019000004057

(51) Int. Cl. B29C 45/26; B29C 45/44; B65D 41/18

(52) U.S. Cl. CPC B29C 45/2681; B29C 45/4407; B29L 2031/565; B65D 41/18; B29C 2045/445; B29C 45/4435

(57) ABSTRACT

A mold for injection molding of a plastic cap having protruding internal portions is provided. The mold has a male mold and a female mold that form a molding cavity. The male mold consists of a mobile portion fitted above a fixed portion, the mobile portion being rotatable around the fixed portion and provided with grooves having an inclined lateral surface that defines an outlet ramp. A method for producing a plastic cap by use of the mold is also provided. The method includes rotating the mobile portion of the male mold with respect to the plastic cap until flat walls of the mobile portion are located in the region of protruding portions of the plastic cap, thereby causing a slight circumferential expansion of the skirt of the plastic cap.

### CROSS-REFERENCE TO RELATED APPLICATIONS

This application is a National Phase Application of PCT International Application PCT/IB2020/052445, having an International Filing Date of Mar. 18, 2020 which claims priority to Italian Application No. 102019000004057 filed Mar. 20, 2019, each of which is hereby incorporated by reference in its entirety.

### TECHNICAL FIELD

A mold and a related injection molding method are provided that makes it possible to extract the molded pieces, in particular pieces comprising internal edges and reduced dimensions. Also provided. is a piece that is molded using the mold and the method above, in particular a plastics cap having internally protruding flaps.

### BACKGROUND

Injection molding is a popular method for producing different types of products, including pieces provided with internal edges. These types of products experience problems during the molding process, in particular when extracting the piece from the mold.

For this reason, molds and related molding methods based on the collapsible nuclei technology and on mechanical systems for conical or linear movement on an inclined plane have been developed. For example, methods are known that provide the use of molds provided with a male part composed of a plurality of portions, portions that are removed in order to create free space inside the mold, space in which the internal edges of the piece are housed such that they do not suffer deformation or damage during extraction from said mold. With reference to a plastics cap having protruding internal flaps, for example, the components of the male part that formed the flaps have to be removed such that the flaps have space that is free of obstructions and the finished cap can be removed from the molding cavity without being damaged.

However, these known molds and methods have a number of disadvantages.

First of all, the molds are very complex, consisting of a large number of parts and components that have to move in a very precise manner with respect to one another.

Furthermore, the known methods are suitable for pieces having medium/large dimensions, but are not applicable to very small parts. In some sectors, for example in the medical or pharmaceutical sector, which are characterized by very small instruments and very precise geometries, this causes a high percentage of non-compliant products.

### BRIEF SUMMARY

The disclosure provides a mold and a related injection molding method, and a molded piece provided with internal edges that are able to solve the problems of the prior art.

In particular, the disclosure provides a mold and a related molding method that, for pieces provided with internal edges and reduced dimensions, allows said pieces to be extracted from the mold without being damaged.

Furthermore, a mold is provided that makes it possible to extract the pieces without damaging them, whilst maintaining a simple structure and a very small number of components.

In addition, the disclosure provides a molded piece, in particular a cap comprising internal edges and reduced dimensions, which is easy to extract from the mold without being damaged.

### BRIEF DESCRIPTION OF THE DRAWINGS

The features and advantages of the mold, the molding method and the cap according to the present invention will be clear from the description given below, by way of non-limiting example, in accordance with the attached figures, in which:

FIG. 1A is a sectional view (along the section plane A shown in FIG. 1C) of a detail of the mold according to the present invention during a molding step using a closed mold and in which plastics material has already been injected into the molding cavity;

FIG. 1B is an enlarged view of a detail of FIG. 1A, in particular of the molding cavity;

FIG. 2A is a sectional view (along the section plane B shown in FIG. 1C) of the mold in FIG. 1A, which has been slightly rotated with respect to the longitudinal axis;

FIG. 2B is an enlarged view of a detail of FIG. 2A, in particular of the molding cavity;

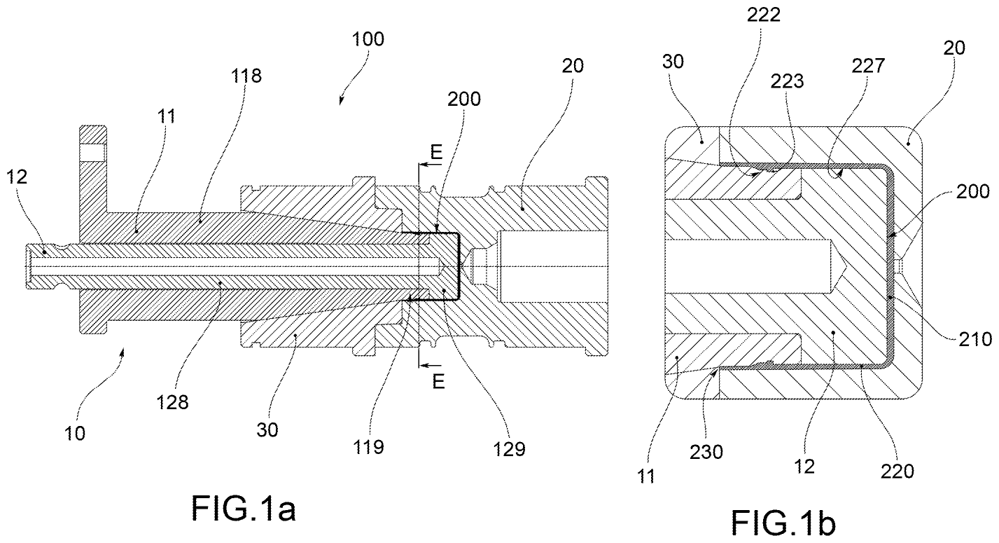

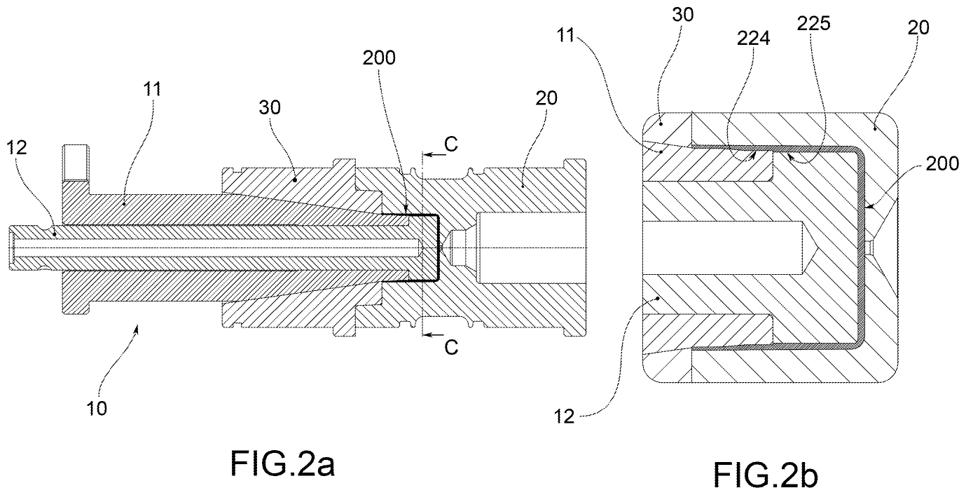

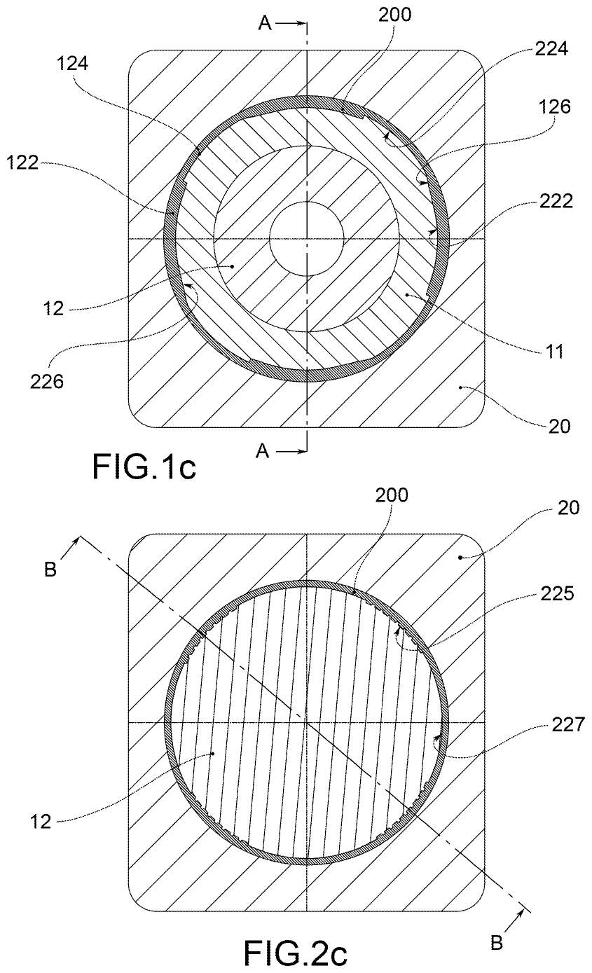

FIG. 1C is a sectional view (along the section plane E shown in FIG. 1B) of the mold in FIG. 1A;

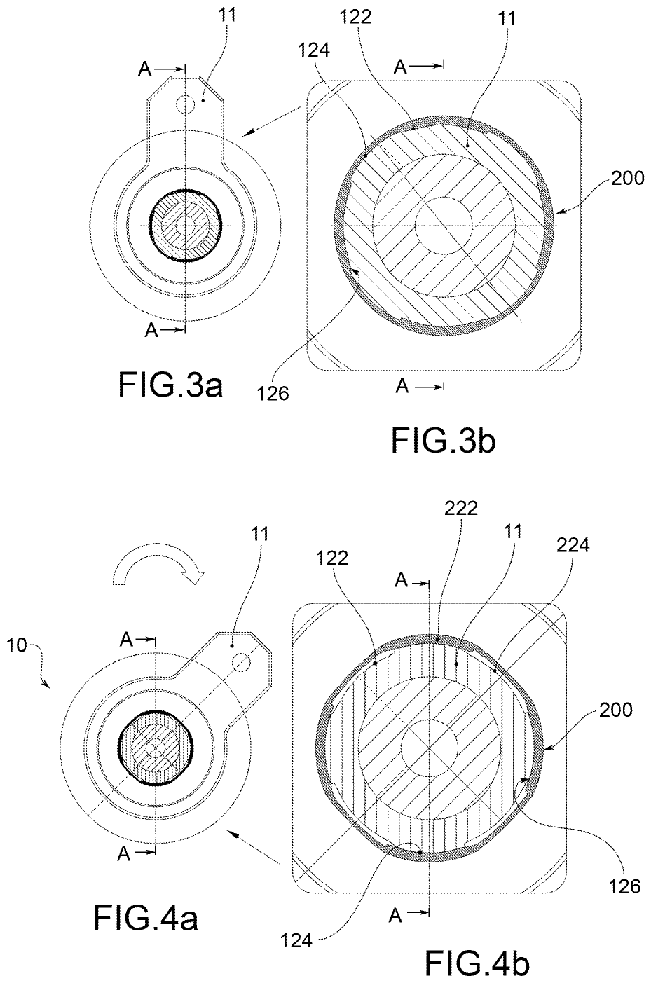

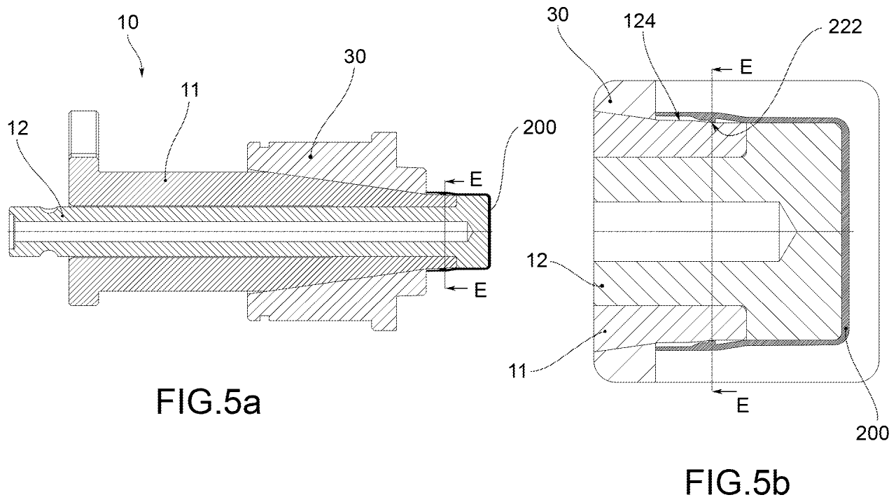

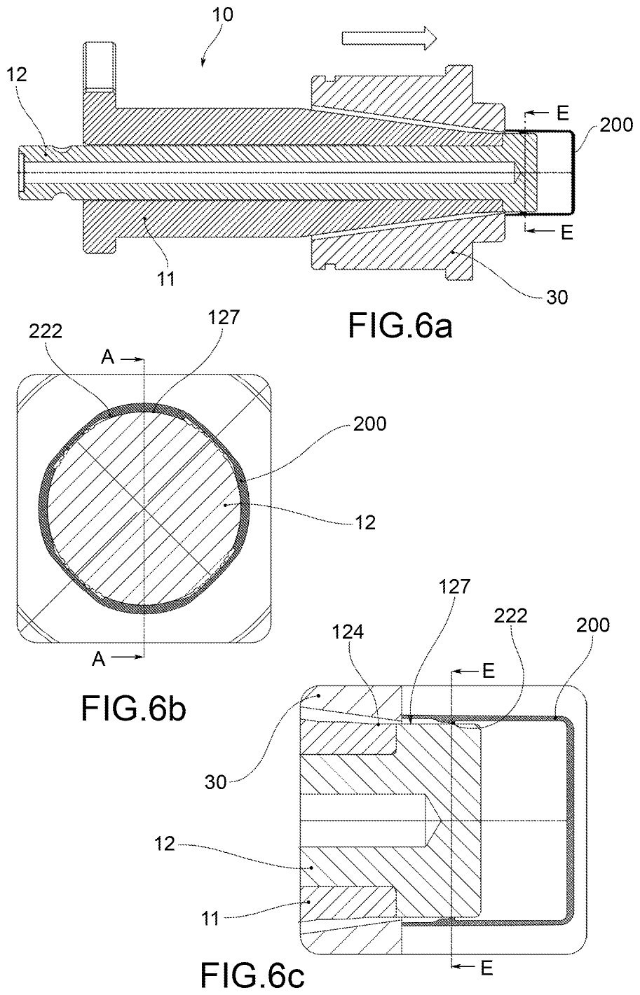

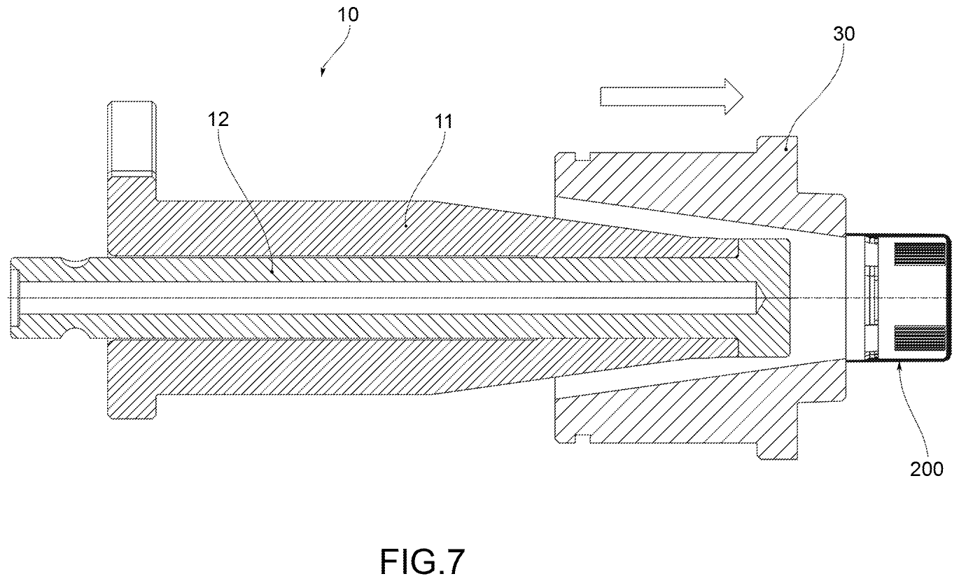

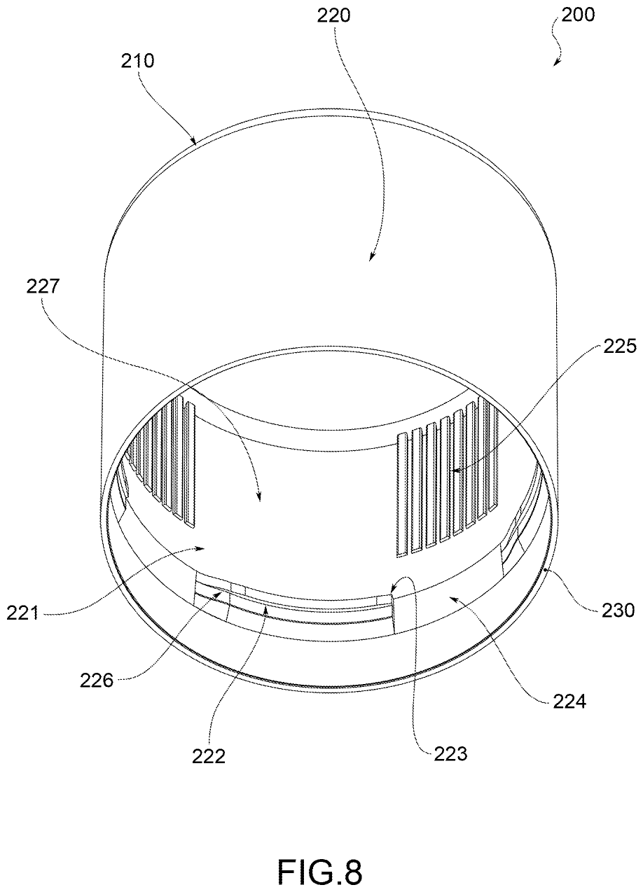

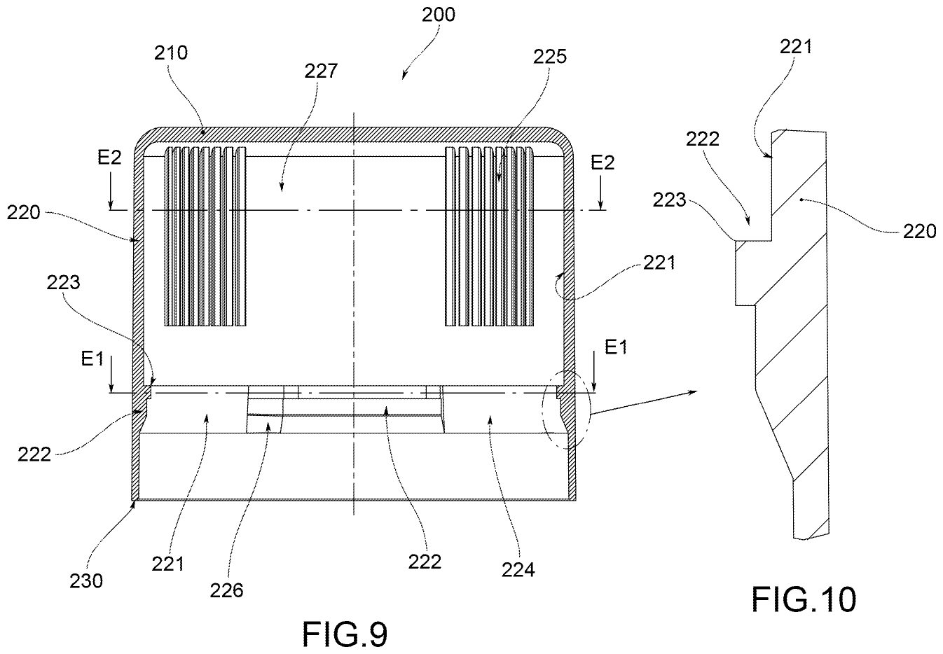

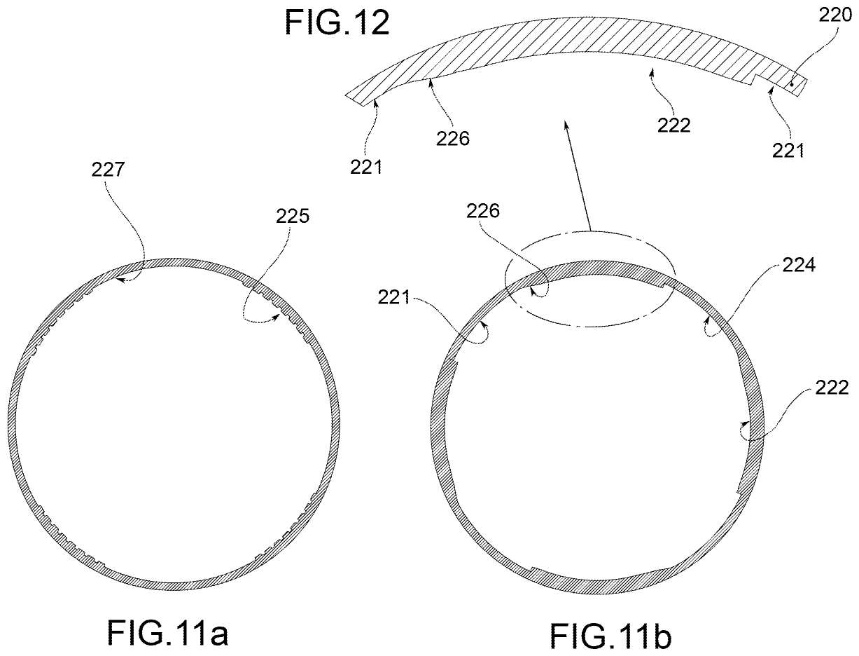

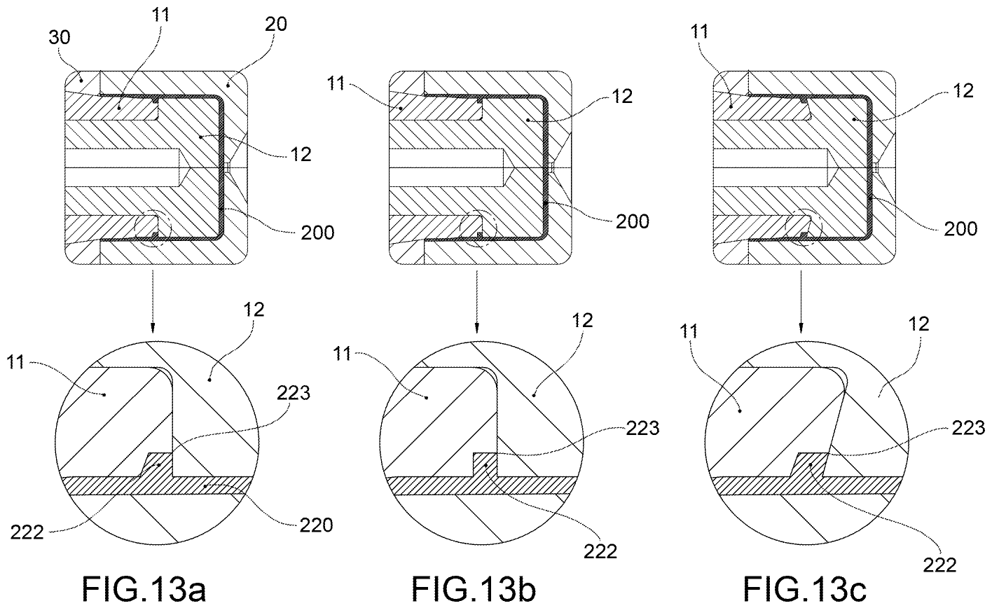

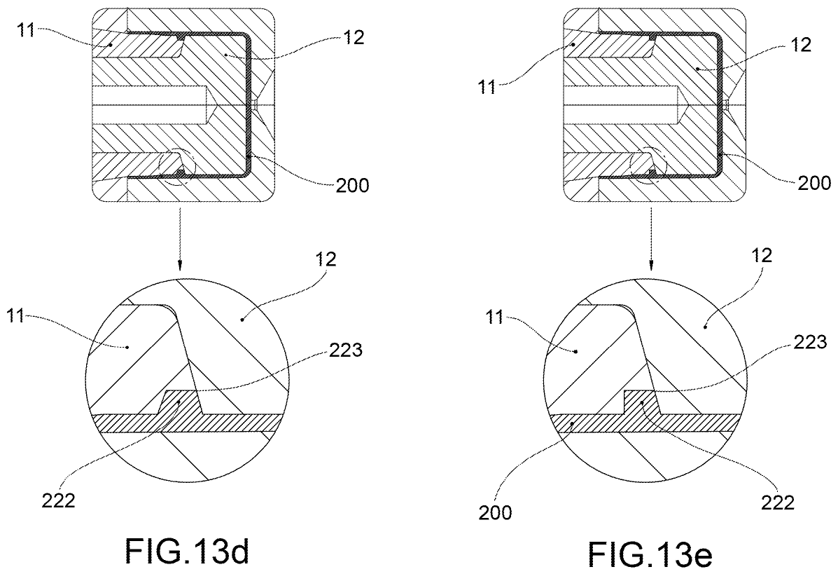

FIG. 2C is a sectional view (along the section plane C shown in FIG. 2B) of the mold in FIG. 2A;

FIG. 3A is a sectional view (along the section plane E shown in FIG. 1B) of the mold in FIG. 1A;

FIG. 3B is an enlarged view of a detail of FIG. 3A;

FIG. 4A is a sectional view (along the section plane E shown in FIG. 5B) of the mold in FIG. 5A, in which the outer male part is shown rotated;

FIG. 4B is an enlarged view of a detail of FIG. 4A;

FIG. 5A is a sectional view (along the section plane A shown in FIG. 4B) of a mold according to the present invention during a subsequent molding step in which the mold is open and the outer male part has been rotated;

FIG. 5B is an enlarged view of a detail of FIG. 5A, in particular of the molded piece;

FIG. 6Ais a sectional view (along the section plane A shown in FIG. 6C) of a mold according to the present invention during a subsequent molding step in which the mold is open and the extractor is advancing;

FIG. 6B is an enlarged view of a detail of FIG. 6A, in particular of the molded piece during extraction;

FIG. 6C is a sectional view (along the section plane E shown in FIG. 6B) of the mold in FIG. 6A;

FIG. 7 is a sectional view of a mold according to the present invention during a subsequent molding step in which the mold is open and in which the extractor is completely advanced and the cap extracted;

FIG. 8 is an axonometric view of a cap according to the present invention, which is provided with internal edges;

FIG. 9 is a sectional view of the cap in FIG. 8;

FIG. 10 is an enlarged view of a detail of the cap in FIG. 9, in particular of the internal edge; this figure is therefore a cross-sectional view of the internal edge;

FIG. 11A is a sectional view (along the section plane E2 shown in FIG. 9) of the cap in FIG. 9;

FIG. 11B shows a sectional view (along the section plane E1 shown in FIG. 9) of the cap in FIG. 9;

FIG. 12 is an enlarged view of a detail of the cap in FIG. 11B, in particular of the internal edge; this figure therefore shows the longitudinal section of the internal edge; and

FIGS. 13a to 13e show a few variants of the mold according to the present invention.

### DETAILED DESCRIPTION

With reference to FIG. 1A to 7, reference numeral 100 indicates a mold according to the present invention, as a whole, for a conventional injection molding machine (not shown), for molding plastics pieces, in particular for a cap 200 provided with internal edges, as shown in FIG. 8.

With reference to FIGS. 8 to 12, reference numeral 200 indicates a cap, or a component of a more complex cap, according to the present invention.

The cap 200 is made of plastics material for injection molding by means of the mold 100.

It should be noted that the cap 200 is a single piece, that is it is formed of one piece, that is each element described below (upper portion 210, skirt 220, protruding portions 222, additional protruding portions 225, etc.) should be considered to be integral therewith.

The cap 200 is particularly suitable for sealing a vial or a container having small dimensions, for example for the medical and pharmaceutical sector.

With reference to FIG. 8, the cap 200 comprises an upper portion 210, below which a cylindrical annular portion extends that defines a skirt 220 that ends in a lower edge 230.

The inner wall 221 of the skirt 220 is provided with portions 222 protruding towards the inside of the cap, portions provided with at least one edge 223 at the top thereof, as shown in FIGS. 9 and 10, for example. These protruding portions can engage with suitable retaining seats (provided on the mouth of the container for which the cap is intended, or on additional components of a more complex cap, for example) by an irreversible snap-in coupling, that is that prevents the cap 200 from disengaging. In order to ensure effective irreversible coupling, it is essential that the protruding portions 222 are provided with sharp edges 223, that is that are not smoothed or rounded (as shown in FIG. 10).

The protruding portion 222 preferably has a predominantly circumferential extension, and the edge 223 also has a predominantly circumferential extension.

The protruding portion 222 is preferably in the form of a step, as shown in FIG. 10.

The cap 200 preferably comprises a plurality of protruding portions 222, which are homogeneously distributed along the inner circumference.

The protruding portions 222 are preferably spaced apart by zones 224 free of obstructions, as shown in FIG. 11B.

The protruding portion 222 is preferably provided with at least one inclined lateral wall 226, which defines a chute (clearly visible in FIGS. 11B and 12) between the protruding portion 222 itself and the inner wall 221 of the skirt 220. This chute can facilitate the rotation of the cap 200 with respect to a mobile portion of the male part of the mold such that the protruding portion 222, and in particular the edge 223, is not damaged or deformed during extraction from the mold 100.

The inner wall 221 of the skirt 220 is preferably provided with additional portions 225 protruding towards the inside of the cap, as shown in FIGS. 9 and 11A, for example, that can make the cap 200 integral with a fixed portion of the male part of the mold.

The additional protruding portion 225 preferably has a predominantly longitudinal extension.

The cap 200 preferably comprises a plurality of additional protruding portions 225, which are homogeneously distributed along the inner circumference.

The additional protruding portions 225 are preferably spaced apart by additional zones 227 free of obstructions, as shown in FIG. 11A.

The additional protruding portion 225 is preferably formed as a longitudinal knurl, as shown in FIG. 11A.

The additional protruding portions 225 are preferably circumferentially offset with respect to the protruding portions 222.

The additional protruding portions 225 are preferably arranged further inwards than the protruding portions 222, that is closer to the upper portion 210 of the cap 200.

Going back to FIG. 1A, the mold 100 internally defines a molding cavity that mirrors the shape of the cap 200.

The mold 100 comprises a male mold 10 that can define the internal portion of the molding cavity and a female mold 20 that can define the external portion of the molding cavity.

In detail, the male mold 10 defines the inner wall 221 of the skirt 220 and the inner wall of the upper portion 210 of the cap; the female mold 20 defines the outer wall of the skirt 220 and the outer wall of the upper portion 210 of the cap.

The mold 100 preferably also comprises an extractor 30 that can push the cap 200 during extraction from the mold. The extractor 30 preferably also contributes to shaping the internal portion of the molding cavity, and in particular the lower edge 230 of the cap, at least in part.

The male mold 10 is composed of just two components: a mobile portion 11 fitted on a fixed portion 12, that is arranged around the fixed portionl2so as to be in contact therewith.

The mobile portion 11 of the male mold 10 is cylindrical, having an annular cross section, and is a single piece, that is it is formed of one piece.

An external zone 118, which is outside the molding cavity, and a main area 119 that defines the molding cavity, at least in part, are identified in the mobile portion 11.

As shown in FIG. 1B, the mobile portion 11 of the male mold 10 defines the protruding portions 222 inside the skirt 220 of the cap. The mobile portion 11 of the male mold 10 in fact comprises grooves 122 in the region of the main area 119, which can define the protruding portions 222 of the cap 200.

The groove 122 has a predominantly circumferential extension.

The mobile portion 11 preferably comprises a plurality of grooves 122, which are homogenously distributed along the outer circumference.

The grooves 122 are preferably circumferentially spaced apart by flat walls 124.

The groove 122 has a polygonal shaped cross section, as shown in FIG. 1B, comprising at least one substantially rectangular or square portion, which is intended to form the step of the protruding portion 222 of the cap 200.

In cross section, the groove 122 comprises at least one sharp angle, this is a well-defined angle, that is a non-rounded nor radius edge, which is intended to form the edge 223 of the protruding portion 222 of the cap 200.

In a non-limiting embodiment, the sharp angle is 90°.

Furthermore, the groove 122 is preferably provided with at least one inclined lateral surface 126, which defines an outlet ramp from the groove 122 itself towards the flat wall 124. The ramp can facilitate the rotation of the mobile portion 11 of the male mold 10 inside the cap 200 such that the protruding portion 222 and the related edge 223 are not damaged or deformed.

It should be noted that, in the mold 100 according to the present invention and to FIGS. 1 to 7, only the mobile portion 11 of the male mold 10 defines the protruding portions 222 inside the skirt 220. In these examples, therefore, the mobile portion 11 is the only portion of the mold 100 that forms, by means of the groove 122, the protruding portions 222 of the cap.

In the mold 100 according to the present invention and to FIGS. 13a to 13e, the fixed portion 12 of the male mold 10 also contributes to defining the protruding portions 222 inside the skirt 200.

In these embodiments, the protruding portions 222 of the cap are defined in the zone where the mobile portion and the fixed portion 12 of the male mold 10join together. In these embodiments, the grooves 122 are arranged in the upper part of the mobile portion 11.

In these examples, too, the grooves 122 are provided with at least one inclined lateral wall 226 that defines a chute that can facilitate the rotation of the cap 200 with respect to the mobile portion 11 of the male part of the mold such that the edge 223 of the protruding portion 222 is not damaged or deformed during extraction from the mold 100.

FIGS. 13a to 13e show a few examples of protruding portions 222 that are provided with sharp edges 223 and are all defined by the grooves 122 in the mobile portion 11 and, at least in the upper part, by the fixed portion 12 of the male mold 10.

In the example in FIG. 13a, the protruding portion 222 is in the shape of a rectangular trapezoid, comprising a sharp edge 223 in the region of the 90° angle; in FIG. 13b, the protruding portion 222 is square; in FIG. 13c, the protruding portion 222 is parallelogram-shaped; in FIG. 13d, the protruding portion 222 is in the shape of an isosceles trapezoid; in FIG. 13e, the protruding portion 222 is in the shape of a rectangular trapezoid comprising a sharp edge 223 in the region of the obtuse angle.

In some embodiments, for example in FIGS. 13a and 13b, the zone where the mobile portion 11 and the fixed portion 12 of the male mold 10join together is substantially flat. In some embodiments, for example in FIGS. 13c to 13e, the zone where the mobile portion 11 and the fixed portion 12 of the male mold 10 join together is inclined towards the outside, as in 13c, and towards the inside, as in FIGS. 13d and 13e.

The fixed portion 12 of the male mold 10 is cylindrical, comprising a substantially T-shaped longitudinal section.

A secondary zone 128, which is intended for insertion inside the mobile portion 11, and a main zone 129 that defines the molding cavity, at least in part, are identified in the fixed portion 12. During molding, when the fixed portion 12 is inserted into the mobile portion 11, the main area 129 of the fixed portion 12 is located outside the mobile portion 11, adjacently above the main area 119 of the mobile portion 11.

As shown in FIG. 2B, the fixed portion 12 of the male mold 10 defines the additional protruding portions 225 inside the skirt 220 of the cap. The fixed portion 12 of the male mold 10 in fact comprises furrows, which can define the additional protruding portions 225, and flat walls 127. The furrows can hold the cap 200, rendering it rotationally integrally fixed to the fixed portion 12 of the male mold 10; at the same time, the furrows make it possible to extract the cap 200 in the axial direction.

The mobile portion 11 can rotate around the fixed portion 12. In particular, as shown in FIGS. 4A to 5B, during extraction from the mold 100 the cap 200 remains integral with the fixed portion 12 of the male mold 10 (on account of the additional protruding portions 225 inserted into the furrows), while the mobile portion 11 of the male mold 10 rotates.

With reference to FIG. 1A to 7, an injection molding method according to the present invention will now be described, which provides the use of the mold 100 for producing the cap 200 that is provided with internal edges.

In a first step shown in FIG. 1A to 3B, the method provides closing the mold 100, that is the male mold 10 and the female mold 20, in order to define the molding cavity, and injecting the plastics material into said cavity, thereby forming the cap 200.

In a subsequent step, the method provides opening the mold 100, for example by withdrawing the female mold 20. As shown in FIG. 4A to 5B, the method therefore provides rotating the mobile portion 11 of the male mold 10 with respect to the newly molded cap 200. In detail, the mobile portion 11 rotates with respect to the fixed portion 12 that, since it is provided with the furrows, drags the newly molded cap 200 into rotation, too.

As shown in detail in FIG. 4B, following the relative rotational movement between the mobile portion 11 and the cap 200, the flat walls 124 of the mobile portion 11 (that have given rise to the free zones 224 of said cap) are located in the region of the protruding portions 222 of the cap 200 that are provided with edges 223. This overlap (flat walls 124 and protrusions 222) causes slight elastic deformation, that is a circumferential expansion, in the region of the skirt 220 of the cap 200, as shown in FIG. 5B.

Furthermore, as visible in FIG. 4B, the grooves 122 in the mobile portion 11 (that have given rise to the protruding portions 222 of the cap) are located in the region of the free zones 224 of the cap 200.

It should be noted that the relative rotational movement between the mobile portion 11 and the cap 200 is facilitated by the presence of the inclined lateral surface 126 inside the groove 122 in the mobile portion 11, which inclined lateral surface acts as a ramp on which the projecting portion 222 of the cap 200 slides towards the flat wall 124 of the mobile portion 11 of the male mold 10.

The same can be said for the inclined lateral wall 226 of the protruding portion 222 of the cap 200, which easily slides towards the flat wall 124 of the mobile portion 11 of the male mold 10, thereby facilitating the rotational movement of said protruding portion 222 without the edge 223 being damaged or deformed.

In a subsequent step shown in FIG. 6A to 7, the method provides extracting the cap 200 from the male mold 10 by advancing the extractor 30. As shown in FIG. 6A, the extractor 30 axially pushes the cap 200 in the region of the lower edge 230, by initially removing it from the mobile portion 11 and then from the fixed portion 12 of the male mold 10, as can be seen in FIG. 6A, until it has been fully removed, shown in FIG. 7.

With reference to FIG. 8, which shows the inner wall 221 of the skirt 220, the protruding portions 222 are arranged axially in the region of the additional zones 227 that are free of obstructions, and therefore in the region of the flat walls 127 of the fixed portion 12 of the male mold 10. Therefore, as can be seen from FIG. 6B, during extraction from the mold, the protruding portion 222 first slides in the region of the flat wall 124 of the mobile portion 11 and then on the flat wall 127 of the fixed portion 12 of the male mold 10: no obstacles are therefore present in the region of the protruding portion 222 that is provided with the edge 223, which portion can be removed from the male mold 10 without being damaged or deformed.

Innovatively, a mold 100 for injection molding as per the present invention makes it possible to produce specific pieces, that is that comprise internal edges and reduced dimensions, and to easily extract them without damaging them.

A mold 100 for injection molding as per the present invention advantageously makes it possible to produce and easily extract the above-mentioned pieces while maintaining a simple structure and a very small number of components.

An injection molding method based on the use of the above-mentioned mold 100 advantageously makes it possible to mold and extract small pieces having internal edges without damaging them by means of a simple and effective procedure.

molded piece using the above-mentioned mold, in particular a cap 200 provided with internal edges and having reduced dimensions, can advantageously be easily extracted from the mold while preserving the sharp edges that are essential for ensuring effective irreversible coupling.

It is clear that an expert in the field could make changes to the mold, the related molding method and to the molded piece described above, which are all covered by the scope of protection defined by the following claims.

1. A mold for injection molding of a plastic cap having an upper portion below which extends a skirt portion provided with an inner wall from which protruding portions protrude integral therewith, said mold comprising a male mold and a female mold forming a molding cavity therebetween,
said male mold consisting of a mobile portion fitted over a fixed portion, said mobile portion being rotatable around said fixed portion and comprising a plurality of grooves in a main area forming the molding cavity,
wherein each groove of said plurality of grooves comprises at least one inclined side surface defining an outlet ramp.

2. The mold of claim 1, wherein the mobile portion is made in one piece.

3. The mold of claim 1, wherein a main area forming the molding cavity is also defined in the fixed portion, and wherein, when the mobile portion is fitted on the fixed portion, the main area of the fixed portion is outside the mobile portion, adjacent over the main area of the mobile portion.

4. The mold of claim 1, wherein each groove of said plurality of grooves has, in cross-section, a polygonal shape with at least one sharp angle.

5. The mold of claim 1, wherein the fixed portion comprises a plurality of grooves in the main area forming the molding cavity, said fixed portion being the only one to form, via the grooves, additional protruding portions inside the skirt portion of the plastic cap.

6. The mold of claim 1, wherein said mobile portion is the only portion of the mold to form, via the grooves, the protruding portions of the plastic cap.

7. The mold of claim 1, wherein the protruding portions of the plastic cap are defined in an area where the mobile portion and the fixed portion of the male mold join together.

8. The mold of claim 1, further comprising an extractor.

9. A method for producing a plastic cap by injection molding, the plastic cap having an upper portion below which extends a skirt portion provided with an inner wall from which protruding portions protrude integral therewith, the method comprising:
preparing a mold comprising a male mold and a female mold forming a molding cavity therebetween, said male mold consisting of a mobile portion fitted over a fixed portion, said mobile portion being rotatable around said fixed portion and comprising a plurality of grooves in a main area forming the molding cavity, wherein each groove of said plurality of grooves comprises at least one inclined side surface defining an outlet ramp, the mold further comprising an extractor, wherein the grooves of said plurality of grooves are interspersed, circumferentially, with flat walls of the mobile portion;
closing the male mold and the female mold defining the molding cavity, and injecting a plastic material into said molding cavity forming the plastic cap;
opening the mold by releasing the plastic cap from the female mold, and rotating the mobile portion of the male mold with respect to the plastic cap until the flat walls of the mobile portion are located at the protruding portions of the plastic cap, resulting in a slight circumferential expansion of the skirt portion of the plastic cap; and
removing the plastic cap from the male mold, by advancing the extractor,
wherein rotating the mobile portion with respect to the plastic cap involves sliding the protruding portion of the plastic cap on the outlet ramp defined by the inclined side surface of the male mold until it emerges from the groove.

10. The method of claim 9, wherein, the fixed portion comprising a plurality of grooves, rotating the mobile portion of the male mold with respect to the plastic cap involves making the plastic cap integral in rotation with the fixed portion via the grooves.

11. The method of claims 9, wherein, the flat walls of the mobile portion being arranged between the grooves, and the fixed portion comprising flat walls, removing the plastic cap from the male mold by advancing the extractor involves sliding the protruding portions of the plastic cap first along the flat walls of the mobile portion and then along the flat walls of the fixed portion of the male mold.

12. A plastic cap obtained by the method of claim 9, the plastic cap having an upper portion below which extends a skirt portion provided with an inner wall from which protruding portions protrude integral therewith, said protruding portions comprising on top sharp edges and laterally at least one inclined side wall defining a chute between the protruding portions and the inner wall of the skirt portion.

13. The plastic cap of claim 12, wherein said protruding portions have circumferential extension and stepped cross-section.

14. The plastic cap of claim 12, wherein, additional protruding portions with longitudinal extension protrude from the inner wall of the skirt portion.

15. The plastic cap of claim 14j, wherein the additional protruding portions are circumferentially offset from the protruding portions.
